(19) United States
(12) Patent Application Publication
(10) Pub. No.: US 2009/0223977 A1
(43) Pub. Date: Sep. 10, 2009

(54) Cookware Vessel with Hollow Rim

(75) Inventor: Stanley Kin Sui Cheng, Vallejo, CA (US)

Correspondence Address: MEYER CORPORATION, U.S.;ATTN: EDWARD S. SHERMAN, ESQ., ONE MEYER PLAZA, VALLEJO, CA, 94590, US

(73) Assignee: MEYER INTELLECTUAL PROPERTIES LIMITED, Hong Kong (CN)

(21) Appl. No.: 12/049,591

(22) Filed: Mar. 17, 2008

Related U.S. Application Data
(63) Continuation-in-part of application No. 29/304,850, filed on Mar. 7, 2008, now Pat. No. D588861.

(51) Int. Cl. A47J 27/00

(52) U.S. Cl. 220/573.1

(57) ABSTRACT

A cookware vessel has a broad and generally rectangular rim that is hollow. The rim is preferably formed by multiply folding the upper portion of the vessels surrounding sidewall, with the last vertical fold being welded to the adjacent side wall of the vessel.

### CROSS REFERENCE TO RELATED APPLICATIONS

The present application is a Continuation in Part of and claims priority to the U.S. Design patent application for a filed on Mar. 7, 2008, for a “Decorative Cooking Vessel”, now having application Ser. No. 29/304,850, which is incorporated herein by reference.

### BACKGROUND OF INVENTION

The present invention relates to an article of cookware and method for fabricating the same, and in particular to cookware vessels having a reinforced rim.

It is noted in the art of metal cookware vessels to form a rim by folding the sidewall outward on itself at the exterior of the vessel to provide reinforcement to the rim.

Typically in such prior methods of folded rim has a round exterior shape, or is rectangular. In either case, a narrow gap is generally left between the sidewall and the edge of the rim. This gap can easily trap liquids or solid food particles during use or cleaning of the cookware vessel, and thus result in unhygienic conditions unless considerably more care or maintenance is used.

Although the folded rim allows the thickness of the cookware vessel wall to be reduced, the rim is still susceptible to mechanical damage that would preclude a tight fit of the intended lid.

Further, normal stainless steel cookware rims are rolled and the surface tension of the rolled rim induces dripping.

It is therefore a first object of the present invention to provide a more hygienic rim for cookware vessels, and with the second objective to provide a rim that is more resistant to mechanical damage.

### SUMMARY OF INVENTION

In the present invention, the first object is achieved by forming a cookware vessel comprising a substantially circular bottom portion, a substantially upright and surrounding sidewall connected to said bottom to define a fluid retaining vessel, and outward extending rim at the top of said upright and surrounding sidewall, the rim having an outward extending portion, a downward extending portion from the end of the outward extending portion, and an inward extending portion from the end of the downward extending portion, wherein the downward extending portion is sealed a lower portion of the sidewall to define a substantially hollow annular cavity.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a cross-sectional elevation of a first embodiment of the invention.

FIG. 2 is a cross-sectional elevation of a second embodiment of the invention.

FIG. 3 is a cross-sectional elevation of the hollow rim portion of the embodiment of FIG.

FIG. 4A-C are cross-sectional elevations illustrating a first embodiment of a method of forming the cooking vessel rim.

FIG. 5A-C are cross-sectional elevations illustrating a second embodiment of a method of forming the cooking vessel rim.

### DETAILED DESCRIPTION

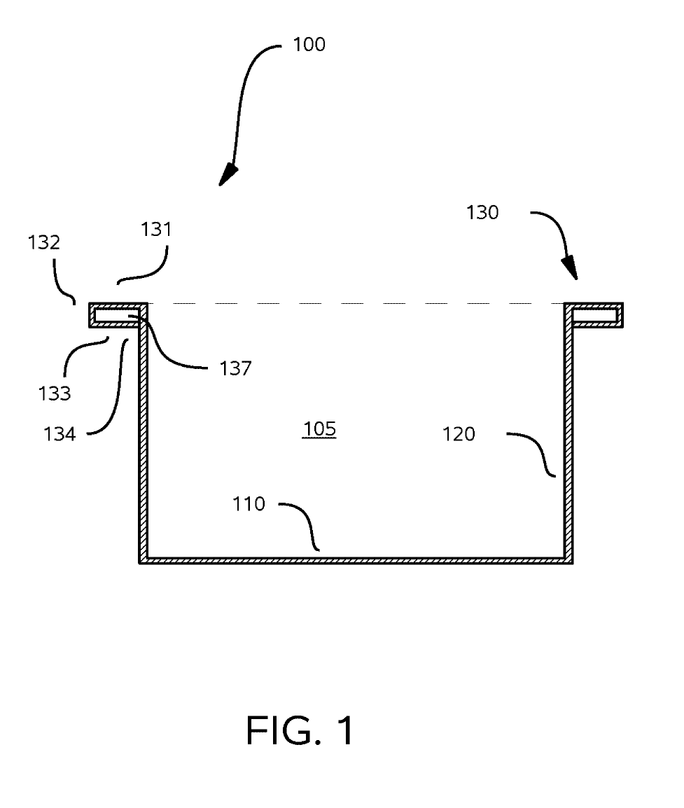

Referring to FIGS. 1 through 5, wherein like reference numerals refer to like components in the various views, there is illustrated therein a new and improved cookware vessel with hollow rim, generally denominated 100 herein.

In accordance with a first embodiment of the present invention shown in FIG. 1, the cookware vessel 100 comprise a substantially circular bottom portion 110, substantially upright and surrounding sidewall 120 connected to the bottom 110 to define a fluid retaining cavity 105. The sidewall 120 terminate the outward extending rim 130. The rim 130 has a hollow interior portion 137 that is defined by an outward extending portion 131 of the sidewall, which at the portion most distal from the vertical sidewall 120 is in turn connected to a downward extending portion 132. The lowest edge of this downward extending portion 132 is in turn connected to an inward extending portion 133. The interior edge of the inward extending portion 133 is joint to the sidewall 120 at seam 134.

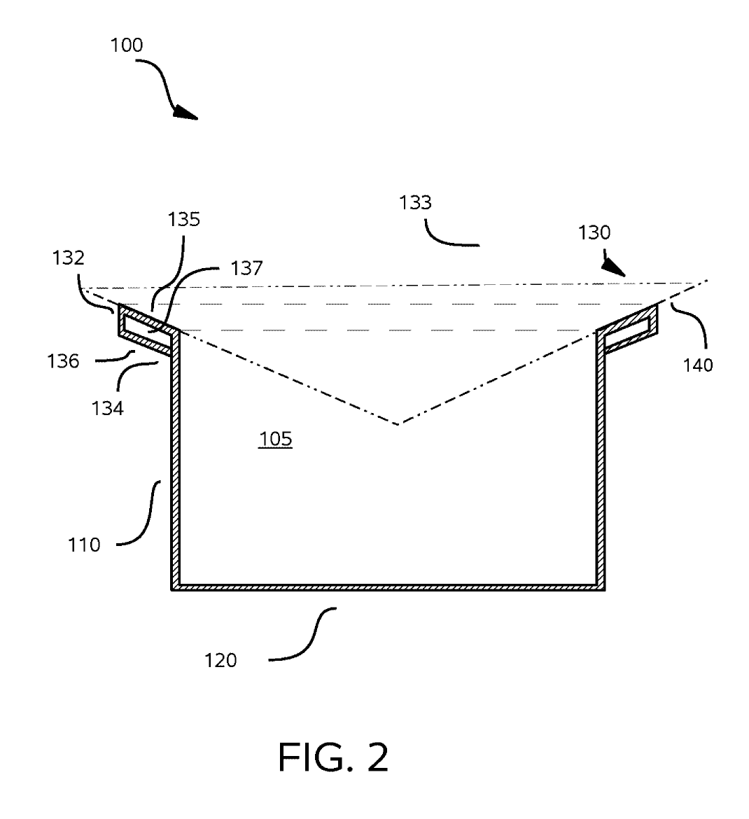

In another embodiment, shown in FIG. 2, the cookware vessel 100 comprise a substantially circular bottom portion 110, substantially upright and surrounding sidewall 120 connected to the bottom 110 to define a fluid retaining cavity 105. The sidewall 120 terminate the outward and upward extending rim 130. The rim 130 has a hollow interior portion 137 that is defined by an upward and outward extending portion 135 of the sidewall, which at the portion most distal from the vertical sidewall 120 is in turn connected to a downward extending portion 132. The lowest edge of this downward extending portion 132 is in turn connected to a downward and inward extending portion 136. The interior edge of the downward and inward extending portion 136 is joined to the sidewall 120 at seam 134.

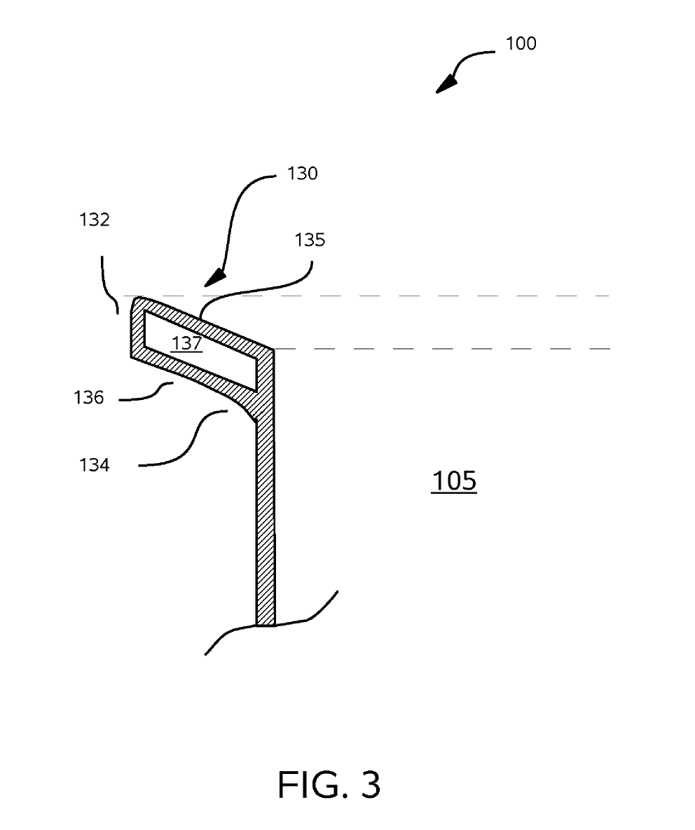

FIG. 3 shows in more detail structure of rim 130 and the welded seam 134. The welded seam 134 is generally rounded at the exterior of the junction with the sidewall 120 so as to completely seal cavity 137 and avoid any recesses or exposed cavity that could contaminants, hence the cooking vessel 100 is more hygienic being easier to maintain in a clean condition.

Further, as rim 130 has an the inverted conical shape as illustrated by dot-dashed line 140, in the embodiment of FIG. 2 or 3, fluid can be poured from any side thereof without dripping or flow down the outside of wall 120.

The hollow rim 130 is stronger tan a conventional single wall rim or folded rim, providing a more consistent shape and resistance to damage that would disturb the fit of a matching shaped lid. Further, the rim 130 having 3 sides, provides more surface area for cooling so that it is safer if touched by accident during cooking, or can be used handle the vessel 100 after cooking as it will cool quicker than an upright edge or rim. The hollow rim reinforces the cookware vessel and because of its shape is more rigid and hence less susceptible to damage from handling.

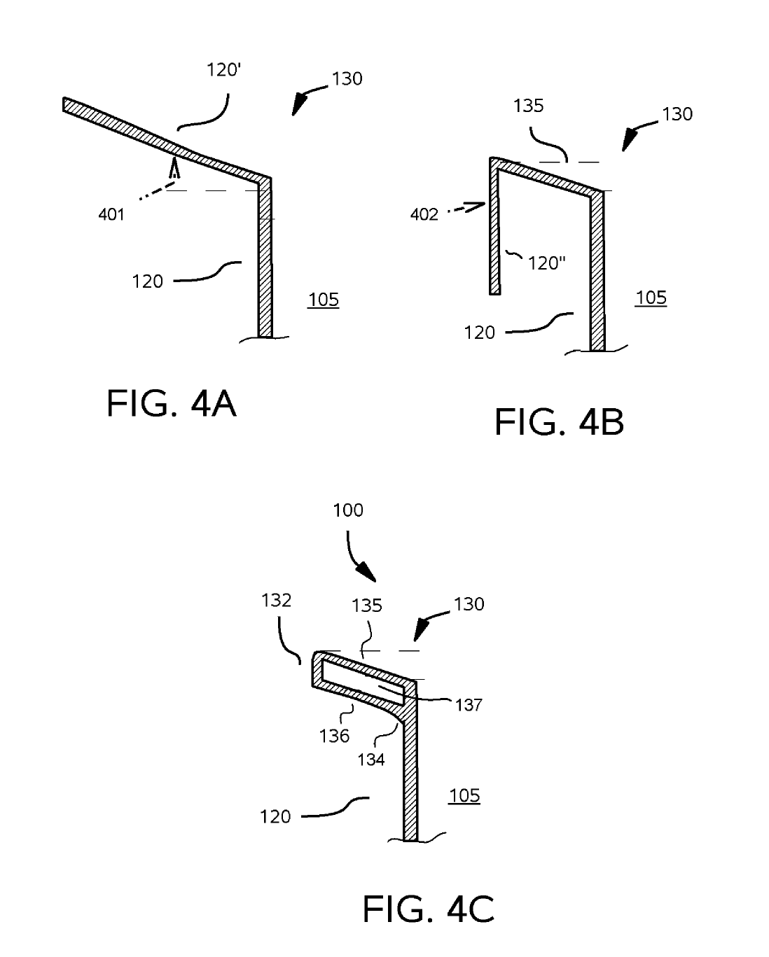

FIG. 4A-C illustrate a first embodiment for a method of forming rim 130 of vessel 100. In FIG. 4A, the upper end 120′ of upright wall 120 is flared upward and outward in the shape of an inverted cone. The upper extent of end 120′ is then bent downward at arrow 140, forming downward portion 120″. In the next step, the end of downward portion 120″ is bent upward parallel to segment 135 at arrow 402. In the final step the end of formerly downward segment 120′ is welded to sidewall 120 at seam 134 to form a hollow cavity 137 in rim 130.

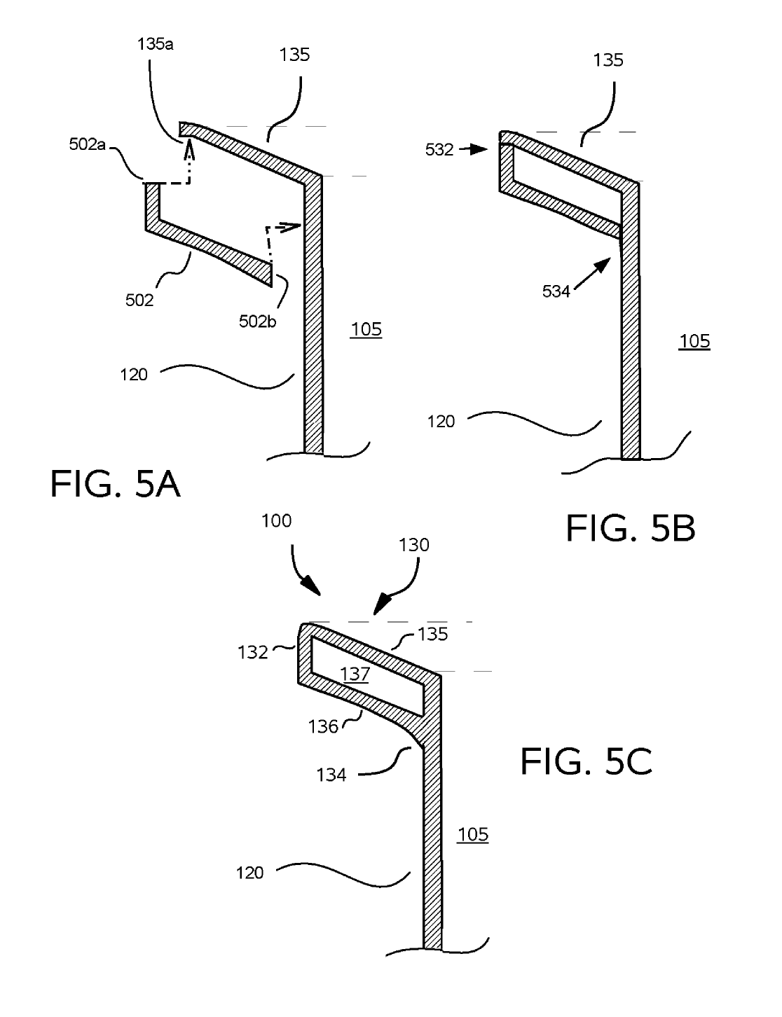

FIG. 5A-C illustrate a second embodiment for a method of forming rim 130 of vessel 100. In FIG. 5A, the upper end 135 of upright wall 120 is initially flared upward and outward in the shape of an inverted cone, terminating at end 135a. A second toroidal segment 502 having a distorted L-shaped cross section shown in FIG, 5A is joined to vessel 100 by first bringing upper end 502a in contact or sufficient proximity to end 135a for welding together, forming joint 532 in FIG. 5B. Further, simultaneously or in a preceding step the lower end 502b of toroidal segment is brought into contact or close proximity with sidewall 120 for welding seam 134 at perimeter shown by arrow 534 in FIG. 5B. Thus, as shown in FIG. 5C when segment 502 is thus attached it forms portion 132 and 136 of rim 130.

The welding processes use to form joints 134 and 534 is of course selected on the characteristics of the metal used to form vessel 100, and as such may constitute MIG or TIG welding for aluminum, however for stainless steel vessels, laser welding is preferred.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. a cookware vessel comprising:
a) a substantially circular bottom portion,
b) a substantially upright and surrounding sidewall connected to said bottom to define a fluid retaining vessel,
c) and outward extending rim at the top of said upright and surrounding sidewall, the rim having an outward extending portion, a downward extending portion from the end of the outward extending portion, and an inward extending portion from the end of the downward extending portion, wherein the downward extending portion is sealed a lower portion of the sidewall to define a substantially hollow annular cavity.

2. The cookware vessel according to claim 1 wherein the outward and inward extending portions of the rim are vertically disposed at substantially parallel to said bottom of the cookware vessel.

3. The cookware vessel according to claim 1 wherein the outward and inward extending portion of the rim extend upward with respect to the inner portion of the vessel to define an inverted conical shaped portion.

4. The cookware vessel of claim 1 wherein the inward extending portion is sealed to the sidewall to by welding.

5. The cookware vessel of claim 4 wherein the welding method is laser welding.

6. The cookware vessel of claim 4 wherein the vessel is fabricated from stainless steel.
